(19) United States
(12) Patent Application Publication
(10) Pub. No.: US 2025/0040783 A1
(43) Pub. Date: Feb. 6, 2025

(54) Power transmission mechanism

(71) Applicant: emz-Hanauer GmbH & Co. KGaA, Nabburg (DE)

(72) Inventors: Albert DIRNBERGER, Neunburg vorm Wald (DE); Timothy Jungsub KIM, Seoul (KR); Stefan MÜLLER, Freihung (DE)

(21) Appl. No.: 18/771,499

(22) Filed: Jul. 12, 2024

(30) Foreign Application Priority Data
Jul. 31, 2023 (DE) 102023120317.7

(51) Int. Cl. A47L 15/42

(52) U.S. Cl. CPC A47L 15/4257; A47L 15/4274

(57) ABSTRACT

The invention relates to a power transmission mechanism for actuating a movable component of an item of household equipment, having a plurality of power transmission branches arranged in parallel for moving a linearly movable coupling part for push and/or pull-transmitting coupling with this movable component, wherein the power transmission branches are provided sequentially depending on sections of a limited movement range of the coupling part and at least one of the power transmission branches includes a torque limiter.

### CROSS-REFERENCE TO RELATED APPLICATIONS

This patent application claims the benefit of and priority to German Patent Application No. 102023120317.7, filed on Jul. 31, 2023, which is herein incorporated by reference in its entirety.

### FIELD OF THE DISCLOSURE

The present invention relates to the technical field of power transmission and more particularly to a power transmission mechanism for actuating a movable component of an item of household equipment according to claim 1, and to an actuator module and a household item for a household having such a power transmission mechanism according to claims 12 and 14, respectively.

### BACKGROUND

In the case of items of household equipment such as a dishwasher, the door is usually opened automatically at the end of the rinsing process. European patent application EP 0 687 439 A1, for example, discloses a dishwasher whose door can be opened a crack wide after completion of the rinsing and drying process via a combination of electric motor, gearbox and closing clamp. The primary purpose of this is to allow steam to escape from the inside of the dishwasher in order to achieve a better drying result. However, it is now desirable for the door to close again by itself afterwards.

One reason for this is to achieve further internal evaporation or post-evaporation for better drying. For example, the German patent application DE 10 2021 113 554 A1 discloses a door mechanism for a dishwasher with an electrically controllable door opener for mechanised door opening and subsequent door closing. On the other hand, especially in Asian regions, people want to close the door again to prevent mosquito larvae or mosquitoes from settling. These particularly like the humid climate inside the dishwasher. A third reason is that an open door is an obstruction in the room.

However, if a door is partially open in the room, a child could, for example, get their fingers caught if the door were to close again on its own. To avoid this, a slip coupling was introduced, as can be seen in patent specification DE 10 2005 028 448 B4. This discloses a dishwasher in which a torque limiter is arranged between a motor and a closing plate. Torque limiters are used to close dishwashers gently and thus make it impossible for a finger to get caught, as the torque limiter would then slip. However, such a gentle closing action does not necessarily lead to a reliable locking of the dishwasher door.

### SUMMARY

It is a task of the present invention to solve the above problems and to provide an improved, in particular securely and reliably closing mechanism for a door of an item of household equipment, preferably a dishwasher.

This task is solved by a power transmission mechanism for actuating a movable component of an item of household equipment according to claim 1, having a plurality of power transmission branches arranged in parallel for moving a linearly movable coupling part for push- and/or pull-transmitted coupling with this movable component, the power transmission branches being provided sequentially as a function of sections of a limited movement range of the coupling part and at least one of the power transmission branches including a torque limiter.

A key point of the present invention is that individual forces can be exerted on the coupling part sequentially (i.e., depending on the successive sections), which in particular enables a defined higher or lower effective velocity of the coupling part across its movement range. At the same time, its force can be reduced in areas where the movable component is particularly susceptible to blockages and increased in a section where the coupling part is about to lock the movable component.

In essence, therefore, a mechanism is provided that can be specifically adjusted to different challenges when operating the movable component of the item of household equipment across the movement range of the coupling part. In particular, this provides a particularly secure and reliable closing mechanism for a door of the household item, preferably a dishwasher.

Preferred embodiments of the power transmission mechanism according to the invention are given in the sub-claims.

In certain advantageous embodiments of the power transmission mechanism according to the invention, it is therefore provided that a plurality of gear pairs arranged in the parallel power transmission branches, each causing a different effective velocity of the coupling part, are provided, which are alternately in meshing engagement in a different section of the movement range of the coupling part. If the coupling part leaves one of the sections, the meshing engagement of the relevant gear pair is released, and another gear pair comes into meshing engagement. The respective gear pairs define a different gear ratio (in the case of cogwheel/rack coupling, the distance travelled by the rack per rotational speed of the cogwheel) and represent a particularly safe and reliable type of power transmission, which can be used to easily influence both the effective velocity and the movement force of the coupling part.

It is advantageous if a first gear toothing of each of the plurality of gear pairs is formed by a rack arrangement coupled to the coupling part for joint linear movement and the second gear toothing of each of the plurality of gear pairs is formed as a cogwheel toothing. The rack arrangement can be formed by a single rack, but alternatively it can also be formed by a plurality of rack pieces which, although arranged to move together, do not necessarily have to be firmly connected to one another.

The second gear toothing of each of the plurality of gear pairs is preferably formed by a circumferential gear toothing extending in particular all the way round, each with a different pitch circle diameter, and the rack arrangement in association with each of the circumferential gear toothing has longitudinal toothing extending in particular over a respective longitudinal section of the rack. An annular extension of the circumferential toothing of the cogwheel means an extension over the entire circumference of the cogwheel.

The circumferential cogwheel teeth and the longitudinal teeth are preferably offset from each other at right angles to the longitudinal direction of the rack, which is a particularly simple design solution in terms of optimising installation space.

A preferred embodiment of the second gear toothing is that each of the plurality of gear pairs comprises cogwheels of different pitch circle diameters, which are arranged axially aligned to each other and of which at least one cogwheel has a torque limiter. By optionally assigning a torque limiter to one of the cogwheels, a risk of injury due to a finger being trapped, for example, can be reliably excluded in its individual power transmission branch. In particular, a power transmission branch can be selected with a gear pair that is effective in a section of the coupling part in which the coupling part operates in a hazardous section of its movement range, in which the movable component of the item of household equipment is particularly wide open.

In principle, the power transmission mechanism can comprise a cog set with several (at least two) cogwheels, each of which belongs to a different gear pair. Alternatively, however, the power transmission mechanism can also comprise separate cogwheels, which form the gear teeth of a respective gear pair.

Preferably, the at least one cogwheel with the torque limiter is arranged adjacent to a drive gear of the power transmission mechanism and the torque limiter is accommodated in this drive gear. As the drive gear usually has a larger pitch circle diameter than the cogwheels of the gear pairs, there is more space available for integrating the torque limiter. At the same time, the cogwheels of the power transmission mechanism are not subject to any size restrictions.

The ability of the power transmission mechanism to operate in different configurations may be independent of the position of the coupling part along its path of movement or may be dependent on the position of the coupling part. In certain advantageous embodiments of the power transmission mechanism according to the invention, it is provided that the sections each have a different section length and the power transmission mechanism is designed at the same drive speed of an electric motor that can be connected to it in such a way that a higher effective velocity of the coupling part is achieved in a section with a longer section length than in another section with a shorter section length. The configuration of the power transmission mechanism depends on the position of the coupling part. If the coupling part is located in a first section of its movement range, the power transmission mechanism causes the coupling part to move at a first effective velocity for a given speed of the electric motor. If the coupling part is located in another, second section of its movement range, the power transmission mechanism causes the coupling part to move at a different, second effective velocity for a given speed of the electric motor.

It is understood that the number of configurations of the power transmission mechanism is not limited to two. Rather, the power transmission mechanism can also be adjustable in three or more different configurations. Accordingly, three or more different sections of the movement range of the coupling part can be defined, each of which differs by a different effective velocity of the coupling part at a given speed of the electric motor. The torque limiter can be provided in at least one of these sections, in particular in a section in which the position of the movable component of the item of household equipment makes it advisable to consider potential blocking by objects.

Preferably, a power transmission branch that includes the torque limiter is provided in a section with a longer section length, so that there is no risk of objects blocking the movement where the movable component of the item of household equipment is particularly wide open.

Conversely, it is preferable if the section length of a section located at an end of the movement range of the coupling part facing the movable component is shorter compared to the section lengths of other sections. If a power transmission branch is provided in this section, the movable component of the item of household equipment can be located just before the closure and only a gap wide open, in which no further blockage of movement by objects can occur. In this short section at one end of the movement range of the coupling part facing the movable component, a particularly high force can then be applied to the coupling part over the short section with the help of a suitable gear pair in order to ensure a powerful and thus reliable closure of the movable component on the household item.

The sections of the movement range in which the power transmission mechanism causes a different effective velocity of the coupling part at a given speed of an electric motor can preferably have different section lengths.

For example, for a given speed of an electric motor, the power transmission mechanism can cause a higher effective velocity of the coupling part in a section with a longer section length than in a section with a shorter section length. Of course, a reverse configuration is also conceivable, so that a section with a shorter section length is accompanied by a higher effective velocity of the coupling part than a section with a longer section length.

Each of the sections of the movement range of the coupling part can, for example, have a section length of at least about 10 mm or at least about 15 mm or at least about 20 mm and/or a section length of at most about 120 mm or at most about 100 mm or at most about 80 mm. These figures are, of course, exemplary and apply to certain embodiments of the invention and are not intended to be fundamentally restrictive.

The above task is also solved by an actuator module according to the invention with the described power transmission mechanism according to claim 12. The actuator module has a module housing in which the power transmission mechanism is coupled to an electric motor and is accommodated between the electric motor and a rack body forming the coupling part. The rack body can be movable in the longitudinal direction of the rack between a feed position, in which the rack body is moved out of the module housing with the coupling part in front, and a retracted position, in which the rack body is retracted into the module housing, in particular at least almost completely. The actuator module can be designed as a prefabricated, mechanically functional actuator module.

A preferred embodiment of the actuator module according to the invention is given in a subclaim.

It is preferable if, at a given speed of the electric motor, the power transmission mechanism of the actuator module causes a lower effective velocity of the coupling part in a first section of the movement range of the coupling part that is closer to the retracted position of the rack body, in particular encompassing the retracted position, and a higher effective velocity of the coupling part in a second section that is further away from the retracted position. The torque limiter can be provided in particular in the power transmission branch of the first section to avoid movement blockages.

The above task is also solved by an item of household equipment according to the invention with the described power transmission mechanism according to claim 14. This household item comprises a movable component and an electric motor for driving the movable component and a coupling part which can be driven by means of the electric motor within a limited movement range, in particular linearly movable, for push and/or pull-transmitting coupling with the movable component. The power transmission mechanism is arranged between the electric motor and the movable component and, at a given speed of the electric motor, is able to ensure a different effective velocity of the coupling part in sections of the movement range. A torque limiter can be activated in a section when the movable component is blocked and the coupling part is travelling at a comparatively higher speed. This ensures that blocking by objects does not pose a risk, especially when the movable component of the item of household equipment is moving quickly.

Preferred embodiments of the household item according to the invention are given in the sub-claims.

The household appliance is preferably an electrical appliance with a usable space formed in a main body of the appliance, wherein the movable component is a door arranged movably relative to the main body of the appliance for closing the usable space. The power transmission mechanism is advantageously designed and controlled for at least one of the following three modes of operation: it operates as a door opener to push open the closed door and/or it operates as a door closer to close the door that is open more than a gap and/or it does not operate against a blockage of the door that is open more than a gap.

The term “door” is to be understood widely in the context of the present disclosure. Both in terms of the direction of movement of the door (swivelling, linear) and the spatial orientation and position of the door (for example upright on a front of the household item or as a flap or lid that can be swivelled upwards on an upper side of the household item), the term door is not intended to be subject to any particular restriction. Accordingly, the door can reach a gap-opening position starting from a closed position by being pushed open a little in a straight line or swivelled about a swivel axis.

According to certain embodiments of the household item according to the invention, the power transmission mechanism according to the invention is set up to cause a lower effective velocity of the coupling part within a first partial movement range of the door comprising a door closed position than in a second partial movement range in which the door is more open than in the first partial movement range. The power transmission mechanism is also set up to activate a torque limiter in the event of a blockage of movement of the coupling part in the second partial movement range.

A control unit of the household item can control the electric motor in such a way that, regardless of the current configuration of the power transmission mechanism and regardless of the current position of the coupling part within its movement range, the electric motor is always operated with a constant supply voltage. Although it is possible that, depending on the current load, the speed of the electric motor may not always remain constant, in such embodiments the supply voltage of the electric motor is not adjusted in order to compensate for possible load and speed fluctuations of the electric motor.

Due to the versatility of the different, parallel arranged power transmission branches of the power transmission mechanism according to the invention, including a torque limiter, the household item can be, for example, a household cooling appliance (for example a refrigerator or freezer), a dishwasher or a laundry treatment machine (for example a washing machine or tumble dryer).

At least in certain embodiments, the coupling of the coupling part with the component to be moved is a releasable (i.e., non-permanent) coupling, which can be designed, for example, as a mechanical stop coupling, a positive-locking coupling or a magnetic coupling.

In certain embodiments, the electric appliance comprises a door lock at the front to keep the door closed. At a given speed of the electric motor, the power transmission mechanism is able to ensure a relatively low effective velocity of the coupling part in a phase in which, when the closed door is opened, a closing holding effect of the door latch still counteracts the pushing open of the door than in a phase in which the closing holding effect of the door latch has already been overcome.

It is understood that the above-mentioned features and those to be explained below can be used not only in the combination indicated in each case, but also in other combinations or on their own, without departing from the scope of the present invention.

### BRIEF DESCRIPTION OF THE DRAWINGS

In the following, a power transmission mechanism according to the invention will be explained in more detail with reference to the enclosed figures. Identical reference signs denote identical or functionally identical components. The figures show:

FIG. 1A a perspective view from an oblique top view of a power transmission mechanism according to the invention for an item of household equipment;

FIG. 1B a perspective view from an oblique top view of the power transmission mechanism of FIG. 1 sectioned transversely to the longitudinal direction;

FIG. 1C a partial side view of the power transmission mechanism of FIG. 1;

FIG. 2 a top view of the coupling part of the power transmission mechanism of FIG. 1;

FIG. 3A a perspective view from diagonally above of the power transmission mechanism of FIG. 1 with the directions of movement for advancing the coupling part;

FIG. 3B a perspective view from above of the power transmission mechanism of FIG. 1 with the directions of movement for retracting the coupling part;

FIG. 4 a side view of the power transmission mechanism of FIG. 1, which is coupled to an electric motor via the drive gear;

FIG. 5A an actuator module with a housing in which an electric motor coupled to the power transmission mechanism of FIG. 1 is accommodated;

FIG. 5B a top view of a combination of the power transmission mechanism of FIG. 1 and an electric motor;

FIG. 6 a top view of a household item with a power transmission mechanism from FIG. 1 exposed on it for opening a movable component;

FIG. 7A the household item of FIG. 6 with a wide-open movable component;

FIG. 7B the household item of FIG. 6 with a gap-opened movable component; and

FIG. 7C the household item of FIG. 6 with a closed movable component.

### DETAILED DESCRIPTION

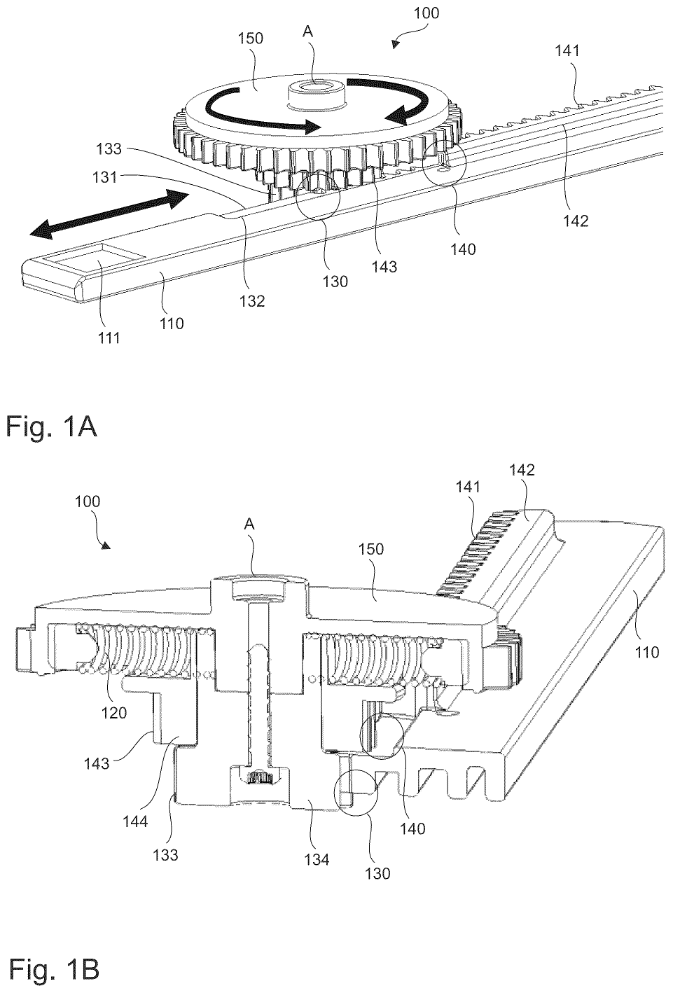

FIG. 1A shows an oblique top perspective view of a power transmission mechanism 100 according to the invention for an item of household equipment. This comprises two different power transmission branches arranged in parallel with respective gear pairs 130, 140. The gear pairs 130, 140 are formed by respective first gear teeth 131, 141 with respective second gear toothing 133, 143 of rack arrangements 132, 142 extending in the longitudinal direction of a coupling part 110. The first gear toothing 131, 141 are formed by respective cogwheels 134, 144 (designated in more detail in FIG. 1B), which have different pitch circle diameters. The rack arrangements 132, 142 are offset in parallel along the coupling part 110 to ensure individual meshing engagement of the associated cogwheels 134, 144. The cogwheels 134, 144 are arranged coaxially with a drive gear 150 on a common axis A. When the drive gear 150 is moved clockwise, for example by an electric motor coupled thereto, the coupling part 110 is fed to the left by meshing engagement of the cogwheels 134, 144 in the gear toothing 131, 141 of the respective rack arrangements 132, 142, and conversely is retracted to the right when the drive gear is moved anti-clockwise. The coupling part 110 has an opening 111 at its front end, into which a movable component of an item of household equipment engages. The power transmission branch, which is defined by the gear pair 140, has a torque limiter 120, which is visible in FIG. 1B.

FIG. 1B shows a perspective view from an oblique top view of the power transmission mechanism 100 of FIG. 1, cut transversely to the longitudinal direction. In particular, a torque limiter 120 is cut free, which is integrated in the drive gear 150 and allows the cogwheel 144 to slip in the event of movement blockages that occur in the area of the rack arrangement 142. The torque limiter 120 is designed as a spring-loaded friction clutch. Since the section TB2 in which the rack arrangement 142 extends is larger than the section TB1 in which the rack arrangement 132 extends, blockages in a particularly wide opening range of a movable component of an item of household equipment can be avoided. At the same time, the effective velocity of the coupling part 110 due to the gear ratio (feed/retraction length of the coupling part 110 per rotation of a gearwheel 134, 144) of the gear pair 130 is greater than the effective velocity of the coupling part 110 due to the gear ratio of the gear pair 130 whose cogwheel 134 has a smaller pitch diameter compared to the cogwheel 144. At the same time, the different gear ratios of the two power transmission branches via the gear pair 130 can reliably provide a greater force for pulling or pushing the movable component into or out of a locking position.

FIG. 1C shows a partial side view of the power transmission mechanism of FIG. 1, in which the meshing engagement of the gear pair 130 is evident. The meshing engagement of the cogwheel 134 with the first gear toothing 131 of the rack arrangement 132 becomes clear. In this position of the coupling part 110, the cogwheel 144 arranged behind the gearwheel 134 on a common axis A is not in meshing engagement with its associated gear toothing 141, which is offset to the left (not visible here) parallel to the gearing 131 and adjoins the gearing 131. The drive gear 150, which can be driven by an electric motor, can be seen behind the cogwheel 144. In this case, high forces can be applied via the short area of the first gear toothing 131 of the rack arrangement 132 and the small gear ratio there between the cogwheel 134 and the rack arrangement 132 to close a movable component that is open with respect to a housing base body. On the other hand, in a region of the rack arrangement 142 and the comparatively higher gear ratio there between the cogwheel 144 and the rack arrangement 142, high effective velocities of the coupling part 110 can be achieved for moving the movable component, in which the torque limiter 120 (visible in FIG. 1B) can become active to avoid blockages of movement.

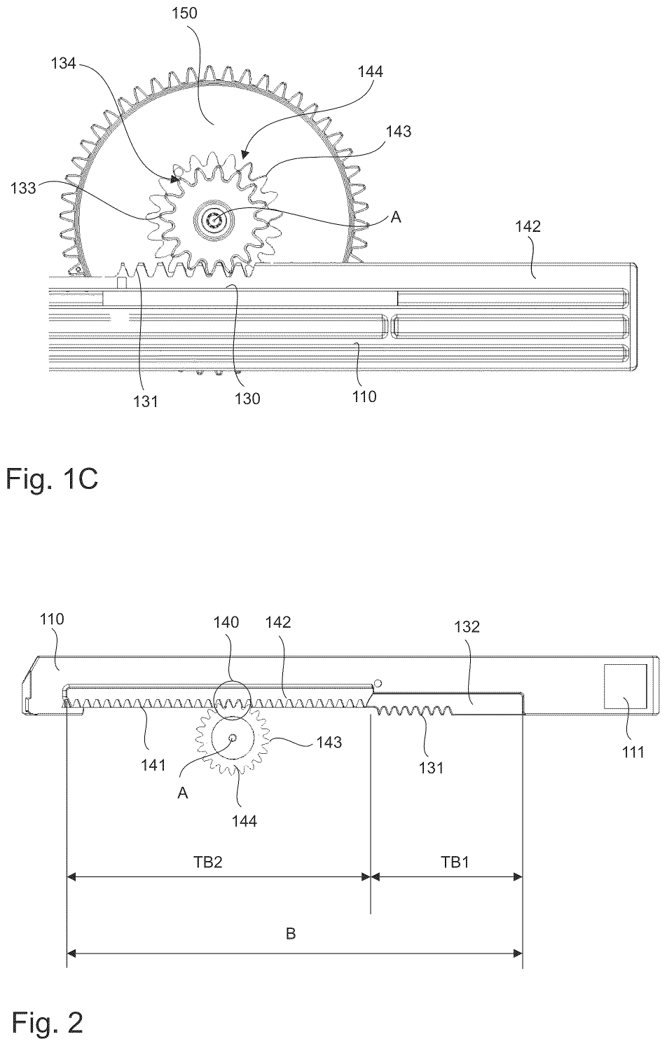

FIG. 2 shows a top view of the coupling part 110 of the power transmission mechanism 100 of FIG. 1, with a first section TB1 and a second section TB2 of a section of the movement range B of the coupling part. In section TB2, the gear pair 140 can be seen with the gear toothing 143 of the cogwheel 144, wherein the gear toothing 143 is in meshing engagement with the gear toothing 141 of the rack arrangement 142. In section TB1, the gear pair 130 would be formed with the gear toothing 133 of the cogwheel 134, in which the gear toothing 133 would be in meshing engagement with the gear toothing 131 of the rack arrangement 132. As can already be seen, inter alia, from FIG. 1A, the section length TB1 and its gear ratio is smaller due to the smaller cogwheel 134 compared to the cogwheel 144, so that a higher opening and closing force can be applied in this section to the coupling part 110 and thus to the movable component of the item of household equipment. The section TB1 is dimensioned such that the movable component of a piece of household equipment is only open by a gap that no longer allows a finger to be trapped, for example. In section TB2, on the other hand, the gear ratio is larger, which applies a lower feed and/or retraction force to the coupling part 110 but increases its effective velocity. In this section TB2, the torque limiter 120 is active, which prevents the movable component from blocking movement. This comparatively wide section TB2 for opening and closing the movable component can thus reliably exclude blockage of movement by objects. The movable component engages in the opening 111 of the coupling part 110 for its movement.

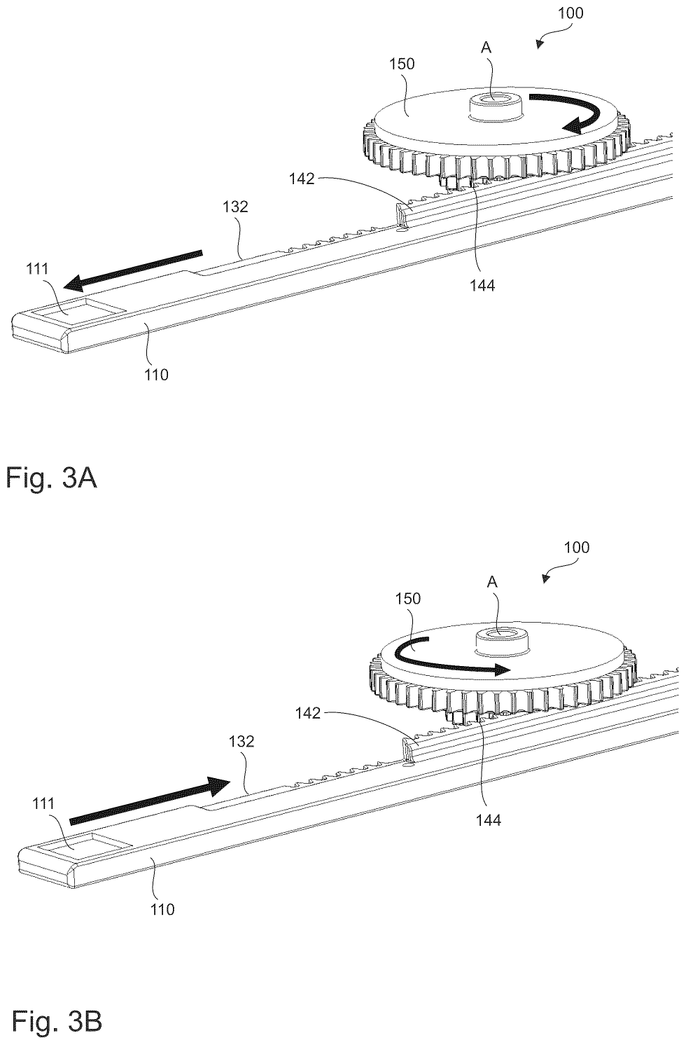

FIG. 3A shows an oblique top perspective view of the power transmission mechanism 100 of FIG. 1 with the directions of movement for advancing the coupling part 110. If the drive gear 150 is driven clockwise, the coupling part 110 is displaced to the left with its opening 111 first via the meshing engagement of the cogwheel 144 and rack arrangement 142.

FIG. 3B shows a perspective view from an oblique top view of the power transmission mechanism of FIG. 1 with the directions of movement for retracting the coupling part 110 when the direction of rotation of the drive gear 150 is reversed. In the representations of FIGS. 3A and 3B, the power transmission branch is active, which includes the section TB2 of the movement range B (shown in FIG. 2), in which the torque limiter is active and a blockage of movement is excluded.

In the first few millimetres of the travel of the coupling part 110, the small cogwheel 134 engages in the section TB1 of the rack arrangement 132. The small cogwheel 134 has a fixed connection with the drive gear 150 of the power transmission mechanism 100. In this section TB1, the torque limiter 120 is not active. As a result, a required higher force can be applied when opening and closing the movable component, which serves to close the movable component 110 so tightly that it is sealed.

After the first section TB1 of the rack arrangement 132, there is a transition where the small cogwheel 134 is no longer engaged and the large cogwheel 144 with torque limiter 120 engages. Up to this point, the power transmission mechanism 100 cannot be operated via the torque limiter 120. This is followed by a transition from the high force to a lower force, whereby from a certain point the movable component can be supported by springs of the household item. This allows a lower force to be required. Due to the design of the power transmission mechanism 100, it always catches in the area of the transition between the sections TB1, TB2, which are provided with and without torque limiter 120 respectively.

In the second section TB2 of the rack arrangement 142, the cogwheel 144 with the torque limiter 120 is then active. In this section TB2, a lower force is applied to the coupling part 110. When the coupling part 110 is extended, the torque limiter 120 can be actuated by pushing or pulling, which provides mechanical overload protection or jamming protection. If the movable component 200, for example a door, is pulled closed, the torque limiter 120 triggers if something gets jammed or a person gets their finger or hand trapped. The door can then be pushed back to the transition to section TB1 by the function of the torque limiter 120. The door can also be pulled open in section TB2 of the torque limiter 120 until a mechanical stop is reached.

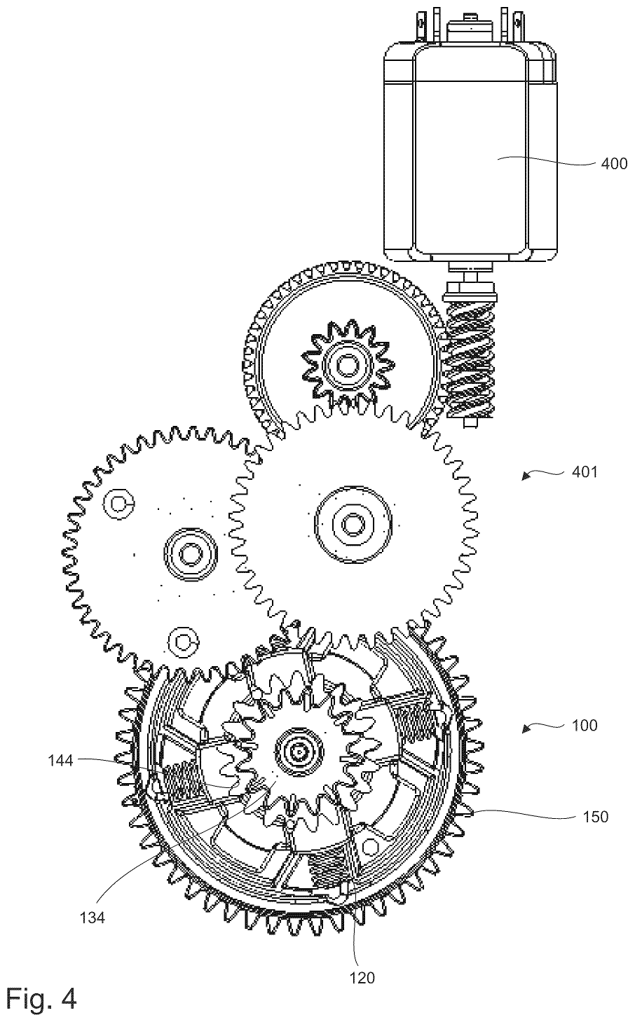

FIG. 4 shows a side view of the power transmission mechanism 100 of FIG. 1, which is coupled to an electric motor 400 via the drive gear 150. The electric motor 400 is coupled to the drive gear 150 of the power transmission mechanism 100 via a reduction gear 401, which comprises a worm gear on the output shaft of the electric motor 400 and a plurality of successively engaging cogwheels. The spring-driven torque limiter 120 is integrated in the drive gear, which acts on the cogwheel 134 and ensures its slippage in the event of a motion blockage. In this case, the spring-based frictional force on a cylindrical shaft of the cogwheel 134 is exceeded by the driving force of the drive gear 150, so that the drive gear 150 continues to rotate, but the cogwheel 144 is blocked and the coupling part 110 together with the movable component connected thereto is not moved any further. The cogwheel 134, on the other hand, is firmly connected to the drive gear 150, with all cogwheels 134, 144 and 150 being arranged along common axis A.

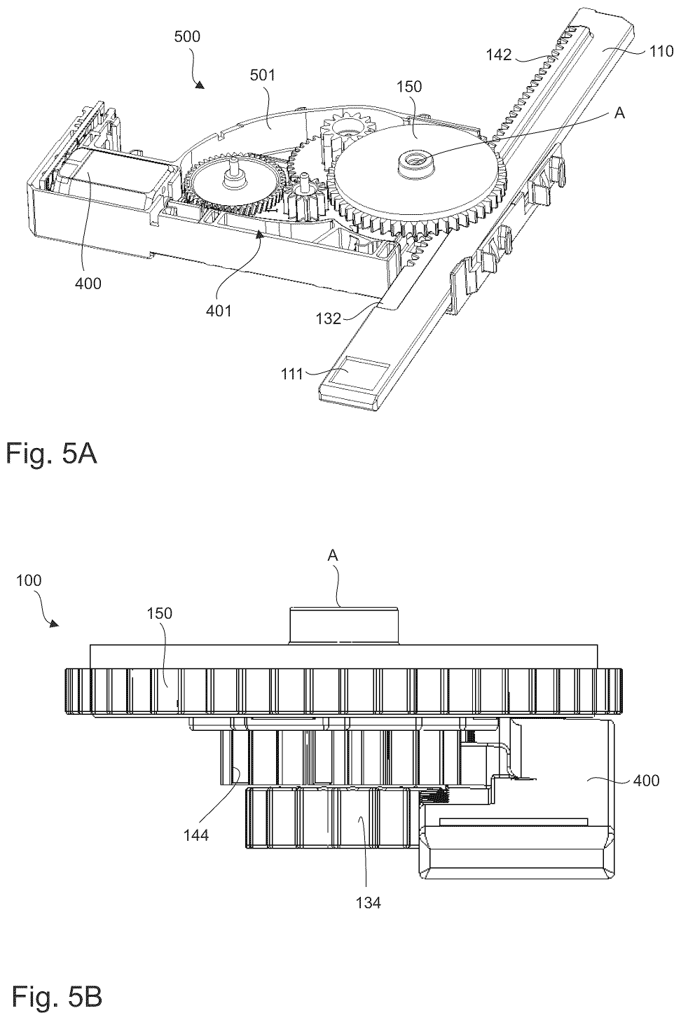

FIG. 5A shows an actuator module 500 with a housing 501 in which an electric motor 400 coupled to the power transmission mechanism 100 of FIG. 1 is accommodated. The actuator module 500 is designed as a prefabricated, mechanically functional actuator module 500 that can be installed in any household items that require a blockage-free opening and closing mechanism. The actuator module 500 has an overall flat design, so that it can be installed in any desired household item.

FIG. 5B shows a top view of a combination of the power transmission mechanism 100 of FIG. 1 and the electric motor 400, in which the equal-axis arrangement of drive gear 150 (with torque limiter 120, not visible here) and cogwheels 134, 144 is visible. While drive gear 150 and cogwheel 134 with a small gear ratio are firmly connected to each other, cogwheel 144 with a larger gear ratio is coupled to drive gear 150 via torque limiter 120.

This results in two power transmission branches, one including the cogwheel 134 and the other including the cogwheel 144, which can be designed as desired with regard to gear ratio and thus power transmission and effective velocity as well as freedom from blockage. These power transmission branches can also be realised in a relatively flat design, as can be seen in FIGS. 5A and 5B.

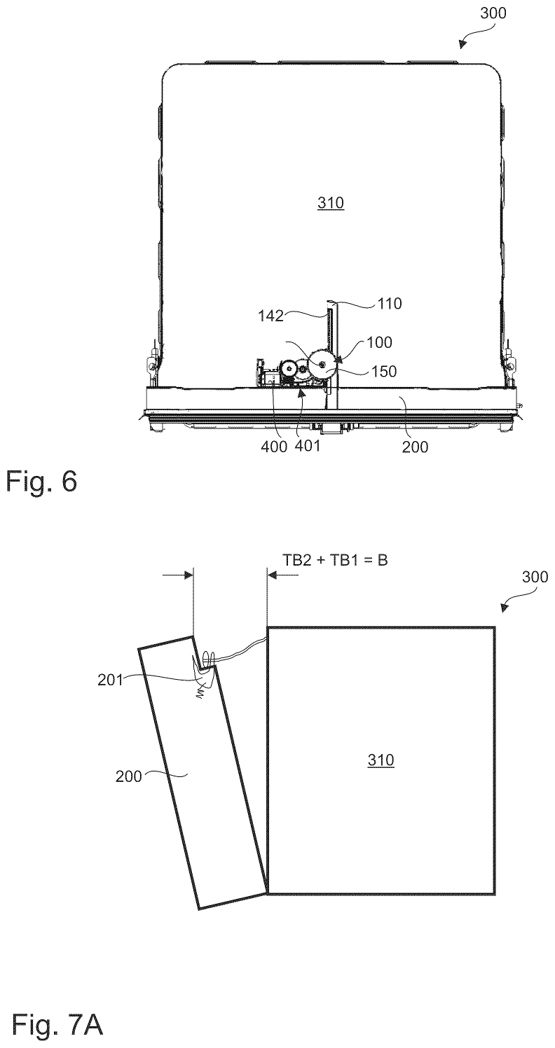

FIG. 6 shows a top view of a household item 300 with a power transmission mechanism 100 of FIG. 1 exposed thereon for opening a movable component 200 on a main body of the appliance 310. In this example, the household item 300 is to be a dishwasher and the movable component 200 is to be a closing flap which is actuated via the power transmission mechanism 100 which is coupled to the electric motor 400. Its reduction gear 401 is geared to the drive gear 150 of the power transmission mechanism 100, which in turn actuates the coupling part 110, into the opening 111 of which the closing flap 200 engages to open and close it. The power transmission mechanism 100 shown can be installed in the form of an actuator module 500 and designed as a prefabricated, mechanically functional actuator module 500.

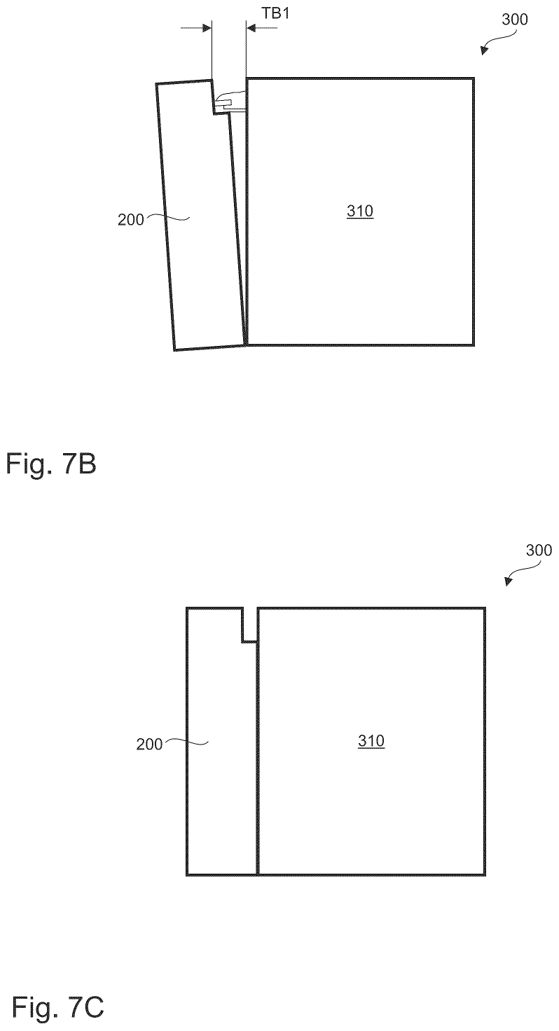

FIG. 7A shows the household item 300 of FIG. 6 with a wide-open closing flap 200, in the movement path of which towards the main body of the appliance 310 a blockage could occur. The coupling part 110 of the power transmission mechanism 100 is extended by the sections TB1 and TB2 of the movement range B, and the closing flap 200 is hooked into the opening 111 of the coupling part 110 via a spring-operated catching latch. Across section TB2, a blockage of movement is excluded in this household item, as the power transmission branch with torque limiter 120 included therein and higher effective velocity of coupling part 110 is active with simultaneously lower power transmission to coupling part 110.

FIG. 7B shows the household item 300 of FIG. 6 with a gap-open closing flap 200 in which, for example, a finger can no longer be trapped. The power transmission branch without torque limiter 120 is now active via this section TB1, which can apply a relatively high closing and opening force to the closing flap 200 at a lower effective velocity.

FIG. 7C shows the household item 100 of FIG. 6 with a closed closing flap 200, in which the coupling part 110 measures its movement range B and the closing flap 200 is locked to the main body of the appliance 310. Even if a movement blockage had occurred in section TB2, the torque limiter 120 would have meant that it could have been removed without damaging the power transmission mechanism 100, the reduction gear 401 or the electric motor 400. The length of the section TB1 is selected so that no finger or other object can be trapped in the gap just before the movable component is fully closed.

Overall, the power transmission mechanism 100 according to the invention results in a household item, in particular a dishwasher, which enables reliable and safe door opening and closing.

### LIST OF REFERENCE SYMBOLS

100 Power transmission mechanism
110 Coupling part
111 Opening from 110
120 Torque limiter
130 Gear pair
131 First gear toothing from 130
132 Rack arrangement from 130
133 Second gear toothing from 130
134 (small) cogwheel
140 Gear pair
141 First gear toothing from 140
142 Rack arrangement from 140
143 Second gear toothing from 140
144 (large) cogwheel
150 Drive gear from 100
200 Movable component (closing flap) from 300
201 Catching latch
300 Item of household equipment
310 Main body of the appliance from 300
400 Electric motor
401 Reduction gear
500 Actuator module
501 Module housing from 600
A Common axis of 134, 144, 150
B Movement range of 110
TB1 (first) section of the movement range
TB2 (second) section of the movement range

What is claimed is:

1. A power transmission mechanism for actuating a movable component of an item of household equipment, the power transmission mechanism having a plurality of power transmission branches arranged in parallel for moving a linearly movable coupling part for push and/or pull-transmitting coupling with the movable component, wherein the power transmission branches are provided sequentially depending on sections of a limited movement range of the linearly movable coupling part, and wherein at least one of the power transmission branches includes a torque limiter.

2. The power transmission mechanism according to claim 1, wherein the power transmission mechanism has a plurality of gear pairs which are arranged in the power transmission branches and in each case bring about a different effective velocity of the linearly movable coupling part and which are in meshing engagement alternately in different sections of the limited movement range of the linearly movable coupling part in each case.

3. The power transmission mechanism according to claim 2, wherein a first gear toothing of each of the plurality of gear pairs is formed by a rack arrangement coupled to the linearly movable coupling part for common linear movement and a second gear toothing of each of the plurality of gear pairs is formed as a cogwheel gear toothing.

4. The power transmission mechanism according to claim 3, wherein the second gear toothing of each of the plurality of gear pairs is formed by a circumferential cogwheel gear toothing extending all round and each having a different pitch circle diameter, and the rack arrangement has a longitudinal gear toothing extending over a respective longitudinal section of the rack arrangement in association with each of the circumferential cogwheel gear toothing.

5. The power transmission mechanism according to claim 4, wherein the circumferential cogwheel gear toothing and the longitudinal gear toothing are each offset relative to one another transversely to a longitudinal direction of the rack arrangement.

6. The power transmission mechanism according to claim 5, wherein the second gear toothing of each of the plurality of gear pairs comprises cogwheels of different pitch circle diameters, respectively, which are arranged axially aligned with each other, of which at least one cogwheel has the torque limiter.

7. The power transmission mechanism according to claim 6, wherein the at least one cogwheel with the torque limiter is arranged adjacent to a drive gear of the power transmission mechanism and the torque limiter is received in the drive gear.

8. The power transmission mechanism according to claim 1, wherein the sections of the limited movement range each have a different section length and the power transmission mechanism is designed at a same drive speed of an electric motor connectable thereto in such a way that a higher effective velocity of the linearly movable coupling part is effected in one of the sections with a greater section length than in another of the sections with a shorter section length.

9. The power transmission mechanism according to claim 8, wherein one of the power transmission branches is provided in the one of the sections with the greater section length, which includes the torque limiter.

10. The power transmission mechanism according to claim 9, wherein the section length of one of the sections located at an end of the limited movement range of the linearly movable coupling part facing the movable component is shorter compared to the section lengths of other sections.

11. The power transmission mechanism according to claim 10, wherein each of the sections has a section length of at least about 10 mm and/or a section length of at most about 120 mm.

12. An actuator module with the power transmission mechanism according to claim 1, wherein the actuator module comprises a module housing in which the power transmission mechanism is coupled to an electric motor and is accommodated between the electric motor and a rack body forming the linearly movable coupling part, wherein the rack body is movable in a longitudinal direction of the rack body between a feed position in which the rack body is moved out of the module housing with the linearly movable coupling part in front and a retracted position in which the rack body is retracted into the module housing at least approximately completely.

13. The actuator module according to claim 12, in which the power transmission mechanism, at a given rotational speed of the electric motor, causes a lower effective velocity of the linearly movable coupling part in a first of the sections of the limited movement range of the linearly movable coupling part which is closer to the retracted position of the rack body and comprises the retracted position, and causes a higher effective velocity of the linearly movable coupling part in a second of the sections which is further away from the retracted position.

14. An item of household equipment with the power transmission mechanism according to claim 1, wherein the item of household equipment comprises the movable component and an electric motor for driving the movable component, and the linearly movable coupling part which can be linearly driven by the electric motor within the limited movement range for the push and/or pull-transmitting coupling with the movable component, wherein the power transmission mechanism is arranged between the electric motor and the movable component and, at a given rotational speed of the electric motor, is capable of ensuring a respectively different effective velocity of the linearly movable coupling part in the sections of the limited movement range, and the torque limiter can be activated at a comparatively higher effective velocity of the linearly movable coupling part in a second of the sections when the movable component is blocked.

15. The item of household equipment according to claim 14, wherein the item of household equipment is an electrical appliance having a usable space formed in a main body of the electrical appliance, and the movable component is a door arranged movably relative to the main body of the electrical appliance for closing the usable space, wherein the power transmission mechanism is designed and controlled for at least one of the three following modes of operation:
the power transmission mechanism works as a door opener to push open a closed door;
the power transmission mechanism works as a door closer to close a gap-opened door; and
the power transmission mechanism does not work against a blockage of a door that is more than ajar.

16. The item of household equipment according to claim 14, wherein the power transmission mechanism is arranged to cause the lower effective velocity of the linearly movable coupling part within a first partial movement range of the door comprising a door closed position than in a second partial movement range at a given speed of the electric motor, in which the door is opened more than in the first partial movement range, and for activating the torque limiter in an event of a movement blockage of the linearly movable coupling part in the second partial movement range.

17. The item of household equipment according to claim 14, wherein the item of household equipment is one of the following: a domestic refrigeration appliance; a dishwashing machine; or a laundry treatment machine.
